(19) United States
(12) Patent Application Publication
(10) Pub. No.: US 2013/0135249 A1
(43) Pub. Date: May 30, 2013

(54) CAPACITIVE TOUCH PANEL, DRIVING METHOD FOR PREVENTING LEAKAGE CURRENT

(71) Applicants: PO-YANG CHEN, Zhubei (TW); FENG-YU KUO, Zhubei (TW); PO-SHENG SHIH, Zhubei (TW); CHIEN-YUNG CHENG, Zhubei (TW); CHUN-LUNG HUANG, Zhubei (TW)

(72) Inventors: PO-YANG CHEN, Zhubei (TW); FENG-YU KUO, Zhubei (TW); PO-SHENG SHIH, Zhubei (TW); CHIEN-YUNG CHENG, Zhubei (TW); CHUN-LUNG HUANG, Zhubei (TW)

(73) Assignee: SHIH HUA TECHNOLOGY LTD., Zhubei City (TW)

(21) Appl. No.: 13/486,662

(22) Filed: Jun. 1, 2012

(30) Foreign Application Priority Data
Nov. 25, 2011 (TW) 100143403

(51) Int. Cl. G06F 3/045

(52) U.S. Cl. 345/174

(57) ABSTRACT

A capacitive touch panel includes a substrate; a transparent conductive layer with anisotropic impedance located on the substrate; a plurality of driving sensing electrodes located on the opposite two sides of the transparent conductive layer; at least one sensing unit connected to the plurality of driving sensing electrodes for scanning the plurality of driving sensing electrodes; at least one voltage compensation unit which provides a offset voltage, at least one voltage compensation unit has a first end and a second end, the first end of at least one voltage compensation unit is at least connected to one of the plurality of driving sensing electrodes, the second end of at least one voltage compensation unit is connected to a grounding voltage. The present application also relates to a driving method for preventing leakage current of the capacitive touch panel.

### RELATED APPLICATIONS

This application claims all benefits accruing under 35 U.S.C. §119 from China Patent Application No. 201110384206.5, filed on Nov. 28, 2011 in the China Intellectual Property Office, the disclosure of which is incorporated herein by reference.

### BACKGROUND

1. Technical Field

The present application relates to a touch panel and a driving method for preventing leakage current, and particularly to a carbon nanotube based capacitive touch panel and a driving method for preventing leakage current.

2. Discussion of Related Art

In recent years, various electronic apparatuses such as mobile phones, car navigation systems have advanced toward high performance and diversification. There is continuous growth in the number of electronic apparatuses equipped with optically transparent touch panels in front of their display devices such as liquid crystal panels. A user of such electronic apparatus operates it by pressing a touch panel with a finger or a stylus while visually observing the display device through the touch panel. Thus a demand exists for such touch panels which is superior in visibility and more reliable. Due to a higher sensitivity, the capacitive touch panels have been widely used.

A capacitive touch panel includes a conductive indium tin oxide (ITO) layer or carbon nanotube layer as an optically transparent layer. The carbon nanotube layer includes a plurality of carbon nanotubes oriented along a same direction. If the transparent layer is a carbon nanotube layer, the capacitive touch panel would drive the electrodes by the resistance anisotropy of the carbon nanotubes. However, the carbon nanotube layer has poor electrical conductivity in the direction perpendicular to the orientation of the carbon nanotubes, because the resistance anisotropy of the carbon nanotubes is limited. Therefore, in the process of driving the electrode, there would be a leakage current in the direction perpendicular to the orientation of the carbon nanotubes in the carbon nanotube layer. The leakage current would make the sensor signal attenuate, and the sensor signal is not easy to find. Thus the sensitivity of the capacitive touch panel would be reduced.

What is needed, therefore, is to provide a capacitive touch panel and a driving method for preventing leakage current.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view showing a structure of one embodiment of a capacitive touch panel.

FIG. 2 is a transverse cross-sectional schematic view along line II-II of the capacitive touch panel of FIG. 1.

FIG. 3 shows a Scanning Electron Microscope (SEM) image of a carbon nanotube layer.

FIG. 4 is a circuit schematic view in the process of driving the driving sensing electrode.

FIG. 5 is a schematic view showing a structure of another embodiment of a capacitive touch panel.

FIG. 6 is a schematic view showing a structure of another embodiment of a capacitive touch panel.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

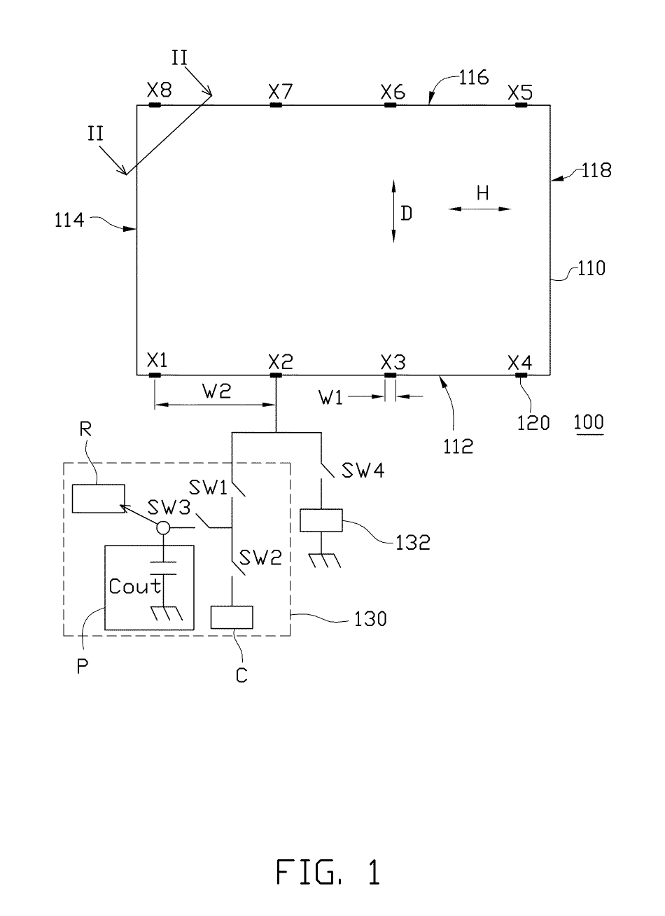

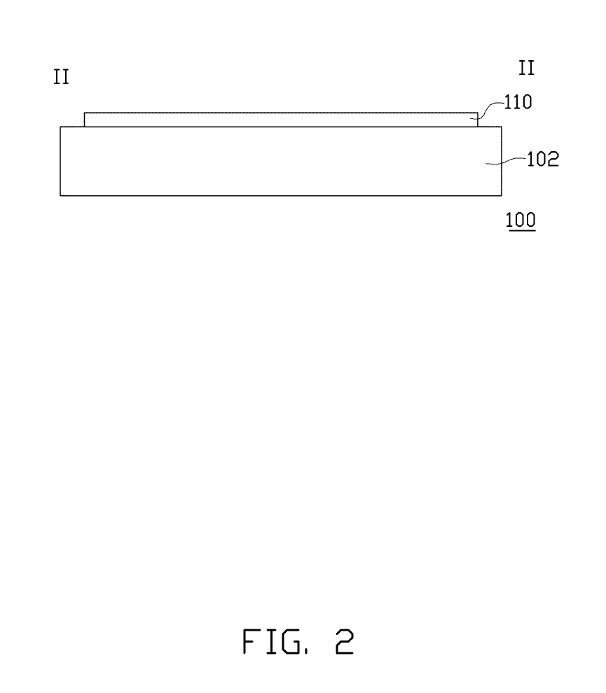

FIG. 1 and FIG. 2 is one embodiment of a capacitive touch panel 100 including a substrate 102, a transparent conductive layer 110, a plurality of driving sensing electrodes 120, a plurality of voltage compensation units 132 and a plurality of sensing units 130. The transparent conductive layer 110 is located on the substrate 102 and has anisotropic impedance. A lower impedance direction D and a higher impedance direction H are defined on the transparent conductive layer 110. The transparent conductive layer 110 includes a first side 112 and a second side 116 that are opposite and parallel to each other. The lower impedance direction D is perpendicular to the first side 112 and the second side 116. The plurality of driving sensing electrodes 120 is located on the first side 112 and the second side 116. Each of the plurality of sensing units 130 and each of the plurality of the voltage compensation units 132 connect to each of the plurality of driving sensing electrode 120. The plurality of sensing units 130 is parallel to the plurality of the voltage compensation units 132. Each of the plurality of voltage compensation units 132 has a first end and a second end. The first end of each of the plurality of the voltage compensation units 132 connects to one of the plurality of driving sensing electrodes 120, the second end of each of the plurality of voltage compensation units 132 connects to a grounding voltage. The capacitive touch panel 100 can be a drive or a drive system, for example.

The substrate 102 can be flat or curved and support other elements. The substrate 102 can be insulative and transparent. The substrate 102 can be made of rigid materials such as glass, quartz, diamond, plastic or any other suitable material. The substrate 102 can also be made of flexible materials such as polycarbonate (PC), polymethyl methacrylate acrylic (PMMA), polyimide (PI), polyethylene terephthalate (PET), polyethylene (PE), polyether polysulfones (PES), polyvinyl polychloride (PVC), benzocyclobutenes (BCB), polyesters, or acrylic resin. In one embodiment, the substrate 102 is a flat and flexible PC plate.

In one embodiment, the transparent conductive layer 110 is a carbon nanotube layer including a carbon nanotube film or a plurality of carbon nanotube films overlapped with each other. The carbon nanotube film includes a plurality of carbon nanotubes substantially parallel to each other, and joined by van der Waals attractive force. The plurality of carbon nanotubes can be oriented along a preferred orientation.

Furthermore, the carbon nanotube film includes a plurality of successively oriented carbon nanotube bundles joined end-to-end by van der Waals attractive force. The plurality of carbon nanotube bundles can be oriented along a preferred orientation and forms a continuous carbon nanotube film.

The carbon nanotube film can be a free-standing structure. The term “free-standing structure” includes carbon nanotube films that can sustain the weight of itself when it is hoisted by a portion thereof without any significant damage to its structural integrity. Thus, the carbon nanotube film can be suspended by one or two spaced supports. The carbon nanotube film has a low impedance along the orientation of the plurality of carbon nanotubes. The carbon nanotube film has a high impedance along the direction perpendicular to the orientation of the plurality of carbon nanotubes. Thus the carbon nanotube film has an anisotropic impedance. In one embodiment, the higher impedance direction H is substantially perpendicular to the orientation of the plurality of carbon nanotubes. The lower impedance direction D is substantially parallel to the orientation of the plurality of carbon nanotubes. If the carbon nanotube layer includes a plurality of carbon nanotube films overlapped with each other, the plurality of carbon nanotubes in the adjacent two carbon nanotubes films are arranged in the same direction.

In one embodiment, the transparent conductive layer 110 is a carbon nanotube layer, and the carbon nanotube layer (for example, a rectangular film) has four sides. The four sides are sequentially a first side 112, a second side 114, a third side 116, and a fourth side 118. The first side 112 and the third side 116 are opposite to each other. The higher impedance direction H is parallel to the first side 112 and the third side 116. The second side 114 and the fourth side 118 are opposite to each other. The lower impedance direction D is parallel to the second side 114 and the fourth side 118.

A method of making the carbon nanotube film includes the steps of:

S21: providing a carbon nanotube array; and

S22: pulling out at least a carbon nanotube film from the carbon nanotube array.

In step S21, a method of forming the carbon nanotube array includes:

S211: providing a substantially flat and smooth base;

S212: forming a catalyst layer on the base;

S213: annealing the base with the catalyst at a temperature in the approximate range of 700° C. to 900° C. in air for about 30 to 90 minutes;

S214: heating the base with the catalyst at a temperature in the approximate range from 500° C. to 740° C. in a furnace with a protective gas therein; and

S215: supplying a carbon source gas to the furnace for about 5 to 30 minutes and growing a super-aligned array of the carbon nanotubes from the base.

In step S211, the base can be a P or N-type silicon wafer. Quite suitably, a 4-inch P-type silicon wafer is used as the base.

In step S212, the catalyst can be made of iron (Fe), cobalt (Co), nickel (Ni), or any combination alloy thereof.

In step S214, the protective gas can be made up of at least one of nitrogen (N₂), ammonia (NH₃), and a noble gas.

In step S215, the carbon source gas can be a hydrocarbon gas, such as ethylene (C₂H₄), methane (CH₄), acetylene (C₂H₂), ethane (C₂H₆), or any combination thereof.

In step S22, a drawn carbon nanotube film can be formed by the steps of:

S221: selecting one or more carbon nanotubes having a predetermined width from the array of carbon nanotubes; and

S222: pulling the carbon nanotubes to form carbon nanotube bundles at an even/uniform speed to achieve a uniform carbon nanotube film.

In step S221, the carbon nanotube bundle includes a plurality of parallel carbon nanotubes. The carbon nanotube bundles can be selected by using an adhesive tape as the tool to contact the super-aligned array of carbon nanotubes. In step S222, the pulling direction is substantially perpendicular to the growing direction of the super-aligned array of carbon nanotubes.

More specifically, during the pulling process, as the initial carbon nanotube bundles are drawn out, other carbon nanotube bundles are also drawn out end to end due to van der Waals attractive force between ends of adjacent bundles. This process of pulling produces a substantially continuous and uniform carbon nanotube film having a predetermined width can be formed.

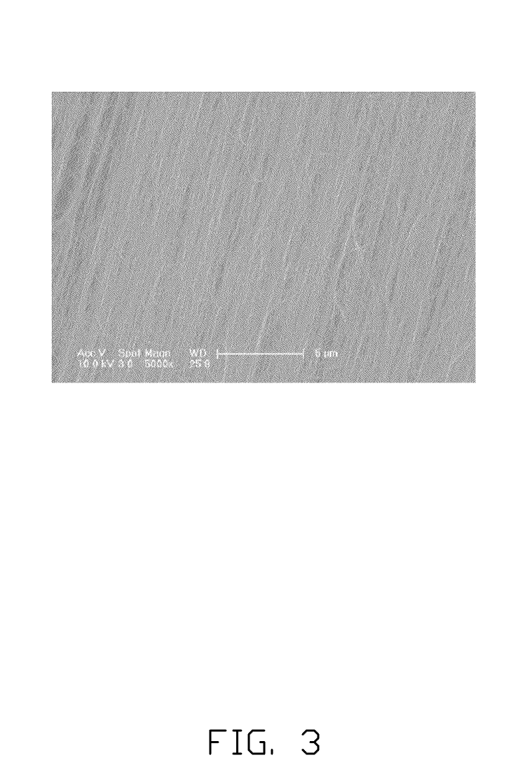

Referring to FIG. 3, the carbon nanotube film includes a plurality of successively oriented carbon nanotube bundles joined end-to-end by van der Waals attractive force. The orientation of carbon nanotubes in the carbon nanotube film is parallel to the pulling direction of the carbon nanotube film.

The carbon nanotubes in the carbon nanotube layer are very pure and have very large specific surface area, so the carbon nanotube layer has strong adhesive and can directly stick to the substrate 102.

The driving sensing electrode 120 can be formed by conductive material, such as metal, conductive polymer, conductive adhesive, metallic carbon nanotubes, or indium tin oxide. The shape and structure of driving sensing electrode 120 are not limited, and can be layered, strip, lump, rod-like or other shapes. In one embodiment, the driving sensing electrode 120 is a silver strip. The plurality of driving sensing electrodes 120 is separately located on the first side 112 and second side 116 of the transparent conductive layer 110. The plurality of driving sensing electrodes 120 is electrically connected to the transparent conductive layer 110.

A length W1 of each of the plurality of driving sensing electrodes 120 is defined, and the length W1 is parallel to the higher impedance direction H. The length W1 of each of the plurality of driving sensing electrodes 120 is not too long, otherwise detecting the position of the touch point is not accurate. So the length W1 of each of the plurality of driving sensing electrodes 120 is in a range from about 1 mm to about 5 mm. There is a distance W2 between the adjacent two driving sensing electrodes 120. The distance W2 is not too large, otherwise detecting the position of the touch point is not accurate. So the distance W2 of adjacent two driving sensing electrodes 120 is in a range from about 1 mm to about 5 mm.

In one embodiment, the number of the driving sensing electrodes 120 is eight, the length W1 of each of the plurality of driving sensing electrodes 120 is about 1 mm, and the distance W2 of adjacent two driving sensing electrodes 120 is about 3 mm. A direction from one of the plurality of driving sensing electrodes 120, on the first side 112, to the corresponded one of the plurality of driving sensing electrodes 120 on the second side 116 is parallel to the lower impedance direction D. Otherwise the direction from one of the plurality of driving sensing electrodes 120 on the first side 112 to the corresponded one of the plurality of driving sensing electrodes 120 on the second side 116 is not parallel to the lower impedance direction D. In one embodiment, a direction from one of the plurality of driving sensing electrodes 120, on the first side 112, to the corresponded one of the plurality of driving sensing electrodes 120, on the second side 116, is parallel to the lower impedance direction D.

The plurality of sensing units 130 includes a charge circuit C, a storage circuit P and a read-out circuit R. The charge circuit C and the storage circuit P are connected in parallel. The read-out circuit R is connected to the storage circuit P. The charge circuit C is connected to a power (not illustrated). The storage circuit P is connected to an external capacitor Cout, for example. In addition, the plurality of sensing units 130 is configured with three switches which are respectively a switch SW1, a switch SW2, and a switch SW3. The switch SW1 is used for controlling whether or not to couple the charge circuit C, the storage circuit P, and the read-out circuit R to the plurality of driving sensing electrodes 120. Moreover, the switch SW2 is used for controlling whether or not to couple the charge circuit C to the switch SW1. And the switch SW3 is used for controlling whether or not to couple the storage circuit P and the read-out circuit R to the switch SW1.

The plurality of voltage compensation units 132 has a first end and a second end, the first end of the plurality of voltage compensation units 132 is connected to the plurality of driving sensing electrodes 120, the second end of the plurality of voltage compensation units 132 is connected to a grounding voltage. In one embodiment, another end of the plurality of voltage compensation units 132 is connected to the ground.

In addition, a switch SW4 is configured between the plurality of driving sensing electrodes 120 and the plurality of voltage compensation units 132, to control whether or not to couple the plurality of voltage compensation units 132 to the plurality of driving sensing electrodes 120. The plurality of voltage compensation units 132 provides a constant offset voltage, such as direct voltage, or a non-constant offset voltage, such as alternating voltage. The plurality of voltage compensation units 132 can be a power supply. The power supply can be a capacitor, for example.

Each of the plurality of driving sensing electrodes 120 is simultaneously connected to each of the plurality of voltage compensation units 132 and each of the plurality of sensing units 130. Each of the plurality of voltage compensation units 132 and each of the plurality of sensing units 130 are connected in parallel. In addition, referring to FIG. 1, in order to make the schematic view clear, the drawing only shows a voltage compensation unit 132 and a sensing unit 130, the voltage compensation unit 132 and a sensing unit 130 are connected in parallel to a driving sensing electrode 120.

When a finger of user or a conductive material touches the capacitive touch panel 100, a touch capacitance would be formed between the transparent conductive layer 110 and the finger (or the conductive material). Once the touch capacitance is formed, the plurality of driving sensing electrodes 120 is sequentially scanned by controlling the switch, to receive a signal from the scanned the plurality of driving sensing electrodes 120. In the process of scanning each of the plurality of driving sensing electrodes 120, the touch capacitance is charged and discharged by the charge circuit C and the storage circuit P alternately. The read-out circuit R can read out the charge parameter of the touch capacitance, such as voltage, as a reference for determining the touch position.

The “sequentially scanning” means that the plurality of driving sensing electrodes 120 is conduced to the plurality of sensing units 130 in batches or one by one. If one driving sensing electrode 120 is connected to one of the plurality of sensing units 130, the rest of the plurality of driving sensing electrodes 120 are conducted to the plurality of voltage compensation units 132. If the plurality of driving sensing electrodes 120 is scanned, the plurality of driving sensing electrodes 120 is connected to the plurality of sensing units 130. If the plurality of driving sensing electrodes 120 is not scanned, the plurality of driving sensing electrodes 120 is connected to the plurality of voltage compensation units 132.

In addition, the scanning sequence is not restricted by the spatial arrangement of the plurality of driving sensing electrodes 120. For example, the plurality of driving sensing electrodes 120 illustrated in FIG. 1 can be scanned from the left side to the right side, from the right side to the left side, at intervals (e.g. every other one, every other two or more, or irregularly).

In detail, the plurality of driving sensing electrodes 120 is sequentially an electrode X1, an electrode X2, an electrode X3, an electrode X4, an electrode X5, an electrode X6, an electrode X7, and an electrode X8. For example, the electrode X2 is scanned. That is to say, the electrode X2 is conducted to one of the plurality of scanning units 130 through the conduction of the switch SW1 and the disconnection of the switch SW4. The switch SW1 is in the plurality of scanning units 130. The switch SW4 is in the plurality of voltage compensation units 132. At the same time, the rest of the plurality of driving sensing electrodes 120 are connected to the plurality of voltage compensation units 132. And the rest of the plurality of driving sensing electrodes 120 are disconnected from the plurality of sensing units 130. If the electrode X2 is conducted to the plurality of voltage compensation units 132, the switch SW4 is conducted and the switch SW1 is disconnected.

The plurality of sensing units 130 can be formed by other units. Any circuit design, capable of connecting to the plurality of driving sensing electrodes 120, to determine the generation of the touch capacitance. These circuit designs can be applied in the layout of the plurality of sensing units 130.

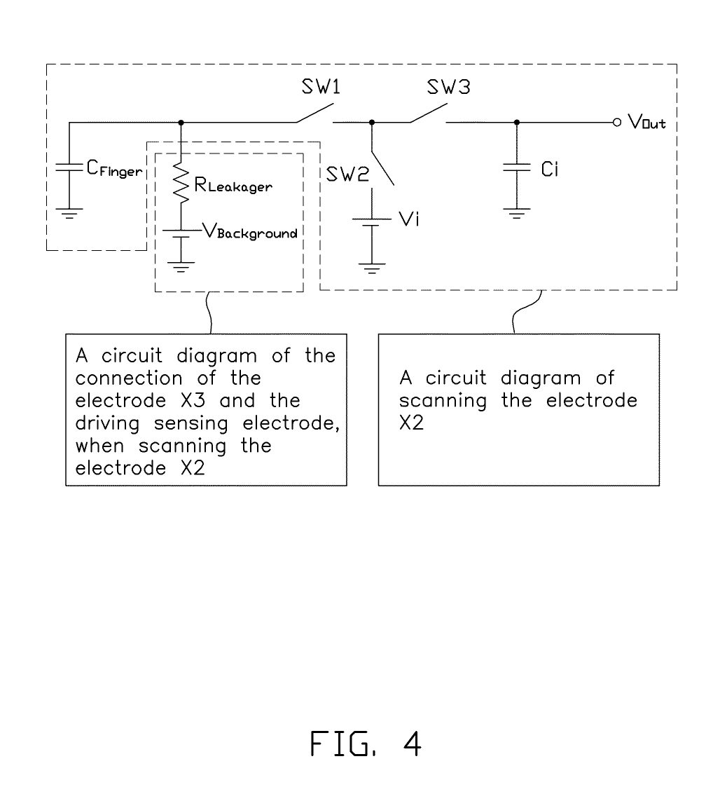

Referring to FIG. 1 and FIG. 4, one embodiment of a driving method for preventing leakage current includes the following steps:

(S30), forming a touch capacitance C_{Finger} by a touch on the capacitive touch panel 100;

(S31), sequentially scanning the plurality of driving sensing electrodes 120 by the plurality of sensing units 130; and in the process of scanning each of the plurality of driving sensing electrodes 120, providing a offset voltage V_{Background} by the rest of the plurality of driving sensing electrodes 120 thought the plurality of voltage compensation units 132; and

(S32), the plurality of sensing units 130 includes a read-out circuit R; and the read-out circuit R can read out the charge parameter of the touch capacitance, as a reference for determining the touch position.

In step (S30), the transparent conductive layer 110 senses a touch, and the touch capacitance C_{Finger} is formed between the transparent conductive layer 110 and an object (e.g. a finger, or a conductive material) who produces the touch.

In step (S31), the plurality of sensing units 130 includes a charge circuit C, a storage circuit P, and a read-out circuit R. The charge circuit C and the storage circuit P are connected in parallel. The read-out circuit R is connected to the storage circuit P. The charge circuit C is connected to a power supply (not illustrated). The storage circuit P is connected to an external capacitor Cout, for example.

For example, the plurality of sensing units 130 is configured with three switches. The switches are respectively a switch SW1, a switch SW2, and a switch SW3. The switch SW1 is used for controlling whether or not to couple the charge circuit C, the storage circuit P, and the read-out circuit R to the plurality of driving sensing electrodes 120. Moreover, the switch SW2 is used for controlling whether or not to couple the charge circuit C to the switch SW1. And the switch SW3 is used for controlling whether or not to couple the storage circuit P and the read-out circuit R to the switch SW1.

If forming the touch capacitance C_{Finger} between the transparent conductive layer 110 and the finger (or the conductive material), the plurality of sensing units 130 sequentially scans the plurality of driving sensing electrodes 120. In the process of scanning each of the plurality of driving sensing electrodes 120, providing the offset voltage V_{Background} by the rest of the plurality of driving sensing electrodes 120. The switch SW1 is in connection and the switch SW4 is in disconnection. The electrode X2 of the plurality of driving sensing electrodes 120 is connected to one of the plurality of sensing units 130 and disconnected from one of the plurality of voltage compensation units 132. Simultaneously, the electrode X1, electrode X3, electrode X4, electrode X5, electrode X6, electrode X7, and electrode X8 are connected to the plurality of voltage compensation units 132. And the electrode X1, electrode X3, electrode X4, electrode X5, electrode X6, electrode X7, and electrode X8 are disconnected from the plurality of sensing units 130 by switch control.

If the electrode X2 is connected to one of the plurality of sensing units 130, disconnecting the SW3 and connecting the SW2, to charge the touch capacitance C_{Finger} by the plurality of sensing units 130. The charge circuit C provides a driving voltage Vᵢ. The electrodes (X3, X4, X5, X6, X7, X8) are connected to the plurality of voltage compensation units 132. So providing the offset voltage V_{Background} by the plurality of voltage compensation units 132 between both ends of the resistor R_{Leakage} in higher impedance direction H of the transparent conductive layer 110. The offset voltage V_{Background} is greater than 0 and less than 2Vᵢ. The offset voltage V_{Background} can be a constant or non-constant offset voltage.

Referring to FIG. 4, in order to make the circuit schematic view clear, the drawing only shows one of the plurality of voltage compensation units 132 connected to the electrode X3. Therefore, the electrical quantity charging into the higher impedance direction H of the carbon nanotube layer reduces or can even be zero. That is to say, the leakage current of the higher impedance direction H of the carbon nanotube layer reduces or can even be zero. Accordingly, the electrical quantity charging into the touch capacitance C_{Finger} increases, even the electrical quantity will be all charged into the touch capacitance C_{Finger}.

After charging of the charge circuit C, the switch SW1 is still connected. The switch SW2 is disconnected, and the switch SW3 is connected, to discharge the touch capacitance C_{Finger} by the plurality of sensing units 130. The storage circuit P provides a storage capacitance Cᵢ. The electrical quantity in the touch capacitance C_{Finger} will all discharge and be stored in the storage circuit P.

In step (S32), if the electrical quantity in the touch capacitance C_{Finger} all discharge and be stored in the storage circuit P, the read-out circuit R will read out the electrical quantity in the storage circuit P. The read-out circuit R in the plurality of sensing units 130 can read out the electrical quantity in the touch capacitance C_{Finger}, such as voltage. And the read-out circuit R produces an output voltage, as a reference for determining the touch position.

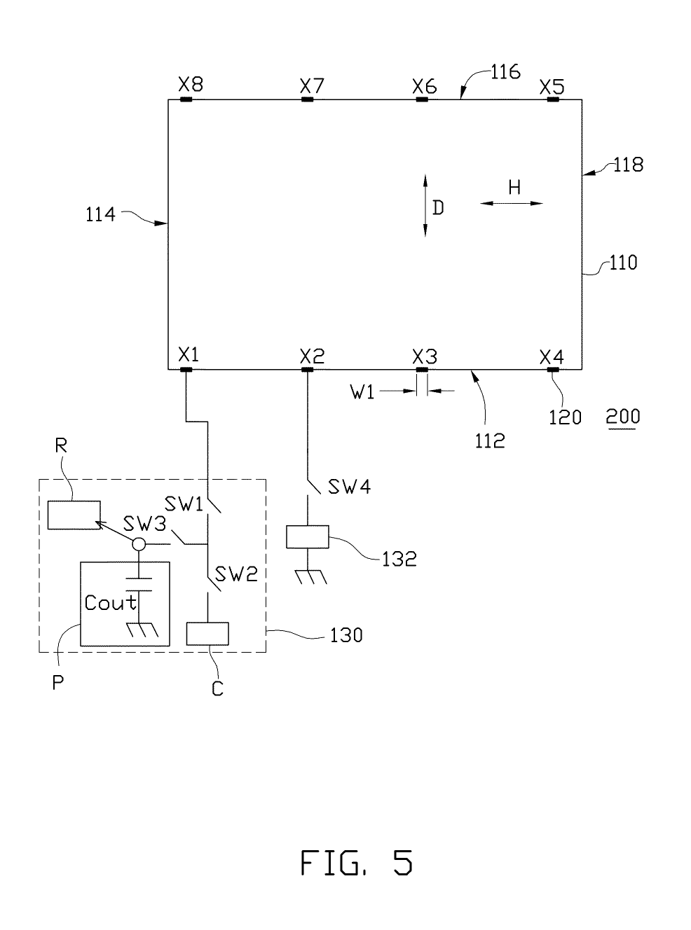

Referring to FIG. 5, a capacitive touch panel 200 of another embodiment includes a substrate 102, a transparent conductive layer 110, a plurality of driving sensing electrodes 120, a sensing unit 130 and at least one voltage compensation unit 132.

The transparent conductive layer 110 is located on the substrate 102 and has anisotropic impedance. A lower impedance direction D and a higher impedance direction H are defined. The transparent conductive layer 110 includes a first side 112 and a second side 116 opposite and parallel to each other. The lower impedance direction D is perpendicular to the first side 112 and the second side 116. The plurality of driving sensing electrodes 120 is located on the first side 112 and the second side 116. The higher impedance direction H is perpendicular to the lower impedance direction D.

The sensing unit 130 is connected to one of the plurality of driving sensing electrodes 120. The plurality of voltage compensation units 132 has a first end and a second end, the first end of the plurality of voltage compensation units 132 is connected to the plurality of driving sensing electrodes 120, the second end of the plurality of voltage compensation units 132 is connected to a grounding voltage. The sensing unit 130 and at least one voltage compensation unit 132 are respectively connected to the different driving sensing electrode 120.

The sensing unit 130 is connected to each of the plurality of driving sensing electrodes 120 respectively through a suitable process or a device, such as switch. If the sensing unit 130 is connected to one of the plurality of driving sensing electrodes 120, the rest of the plurality of driving sensing electrodes 120 are connected to the plurality of voltage compensation units 132 through switches and other devices.

The plurality of voltage compensation units 132 can be a single voltage compensation unit 132. If one of the plurality of the driving sensing electrodes 120 is connected to the sensing unit 130, the rest of the plurality of driving sensing electrodes 120 is simultaneously connected to the single voltage compensation unit 132.

In detail, the plurality of driving sensing electrodes 120 in the capacitive touch panel 200 are sequentially an electrode X1, an electrode X2, an electrode X3, an electrode X4, an electrode X5, an electrode X6, an electrode X7, and an electrode X8. For example, if the electrode X1 is connected to the sensing unit 130, the electrode X2, electrode X3, electrode X4, electrode X5, electrode X6, electrode X7, and electrode X8 are simultaneously connected to the single voltage compensation unit 132.

The number of the plurality of voltage compensation units 132 can be two or more. If the plurality of driving sensing electrodes 120 is disconnected from the sensing unit 130, the rest of the plurality of driving sensing electrodes 120 are connected to each of the plurality of voltage compensation units 132.

For example, the plurality of driving sensing electrodes 120 in the capacitive touch panel 200 is sequentially an electrode X1, an electrode X2, an electrode X3, an electrode X4, an electrode X5, an electrode X6, an electrode X7, and an electrode X8. If the electrode X1 is connected to the sensing unit 130, the electrode X2, electrode X3, electrode X4, electrode X5, electrode X6, electrode X7, and electrode X8 are connected to one of the plurality of voltage compensation units 132 respectively.

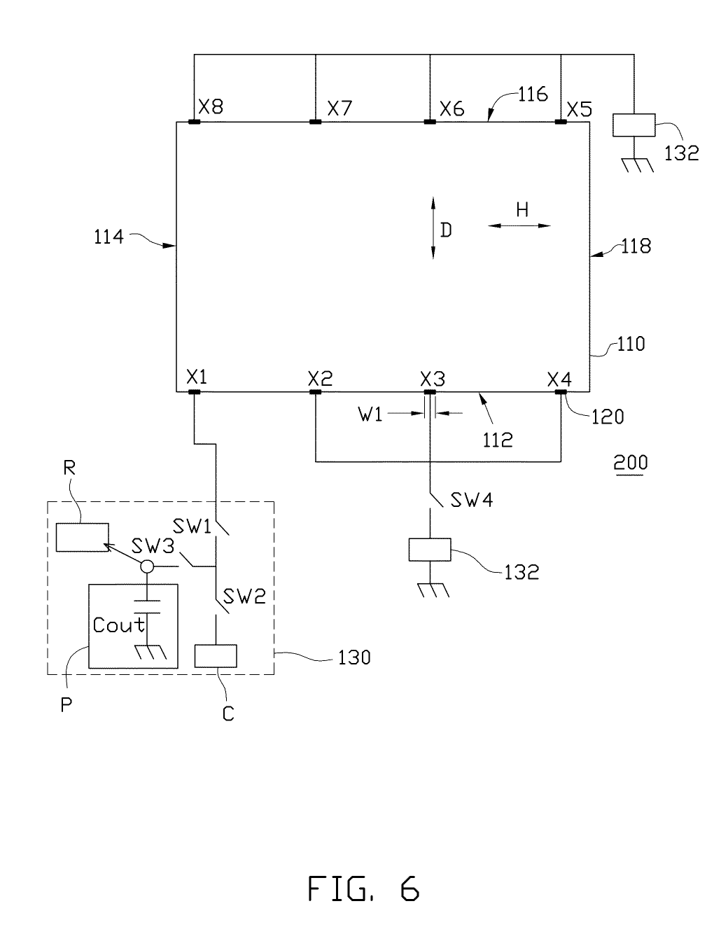

Furthermore, referring to FIG. 5, the schematic view only shows that one of the plurality of voltage compensation units 132 is connected to one of the plurality of driving sensing electrodes 120 herein, to make the schematic view clear. One of the plurality of voltage compensation units 132 can be connected to each of the plurality of driving sensing electrodes 120. Referring to FIG. 6, the electrode X2, the electrode X3 and the electrode X4 are simultaneously connected to one of the plurality of voltage compensation units 132, and the electrode X5, the electrode X6, electrode X7 and the electrode X8 are simultaneously connected to one of the plurality of voltage compensation units 132.

The capacitive touch panel 200 is similar to the capacitive touch panel 100. The difference between the capacitive touch panel 200 and the capacitive touch panel 100 is: in the capacitive touch panel 100, each of the plurality of driving sensing electrodes 120 is simultaneously connected to one of the plurality of sensing units 130 and one of the plurality of voltage compensation units 132; in the capacitive touch panel 200, the plurality of sensing units 130 and the plurality of voltage compensation units 132 are respectively connected to different driving sensing electrode 120.

In summary, if one of the plurality of driving sensing electrodes 120 is connected to one of the plurality of sensing units 130, the rest of the plurality of driving sensing electrodes 120 are connected to one of the plurality of voltage compensation units 132. The plurality of voltage compensation units 132 provides an offset voltage. The offset voltage reduces or eliminates the leakage current. The offset voltage improves the sensitivity of the capacitive touch panel 100 or 200. Moreover, the structure of the capacitive touch panel 100 or 200 is simple and easy to implement.

It is to be understood that the above-described embodiment is intended to illustrate rather than limit the disclosure. Variations may be made to the embodiment without departing from the spirit of the disclosure as claimed. The above-described embodiments are intended to illustrate the scope of the disclosure and not restricted to the scope of the disclosure.

It is also to be understood that the above description and the claims drawn to a method may include some indication in reference to certain steps. However, the indication used is only to be viewed for identification purposes and not as a suggestion as to an order for the steps.

What is claimed is:

1. A capacitive touch panel, comprising:
a substrate;
a transparent conductive layer with anisotropic impedance located on the substrate, a lower impedance direction D and a higher impedance direction H are defined on the transparent conductive layer, the lower impedance direction D is perpendicular to the higher impedance direction H;
a plurality of driving sensing electrodes located on the two opposite sides of the transparent conductive layer, the plurality of driving sensing electrodes is located along a direction perpendicular to the lower impedance direction D;
at least one sensing unit connected to the plurality of driving sensing electrodes for scanning the plurality of driving sensing electrodes;
wherein the capacitive touch panel comprises at least one voltage compensation unit configured to provide an offset voltage, and the at least one voltage compensation unit comprises a first end and a second end, the first end of at least one voltage compensation unit is connected to at least one of the plurality of driving sensing electrodes, the second end of at least one voltage compensation unit is connected to a grounding voltage.

2. The capacitive touch panel of claim 1, wherein each of the plurality of driving sensing electrodes is simultaneously connected to one sensing unit and one voltage compensation unit, and the at least one sensing unit and the at least one voltage compensation unit are connected in parallel.

3. The capacitive touch panel of claim 1, wherein one sensing unit is sequentially connected to each of the plurality of driving sensing electrodes, when one of the plurality of driving sensing electrodes is connected to the at least one sensing unit, the rest of the plurality of driving sensing electrodes are connected to the at least one voltage compensation unit.

4. The capacitive touch panel of claim 1, wherein the at least one voltage compensation unit is a power supply.

5. The capacitive touch panel of claim 4, wherein the power supply is a capacitor.

6. The capacitive touch panel of claim 1, wherein the at least one sensing unit comprises a charge circuit, a storage circuit and a read-out circuit; the charge circuit and the storage circuit are connected in parallel; and the read-out circuit is connected to the storage circuit.

7. The capacitive touch panel of claim 1, wherein if the plurality of driving sensing electrodes is scanned, the plurality of driving sensing electrodes is connected to the at least one sensing unit; if the plurality of driving sensing electrodes is not scanned, the plurality of driving sensing electrodes is connected to the at least one voltage compensation unit.

8. The capacitive touch panel of claim 1, wherein the transparent conductive layer is a carbon nanotube layer comprises a carbon nanotube film or a plurality of carbon nanotube films overlapped with each other.

9. The capacitive touch panel of claim 8, wherein the carbon nanotube film comprises a plurality of carbon nanotubes parallel to each other, and the plurality of carbon nanotubes is oriented along a preferred orientation.

10. The capacitive touch panel of claim 8, wherein the carbon nanotube film comprises a plurality of carbon nanotube bundles oriented along a preferred orientation, and the plurality of carbon nanotube bundles joins end-to-end by van der Waals attractive force and forms a continuous carbon nanotube film.

11. The capacitive touch panel of claim 1, wherein a length of each of the plurality of driving sensing electrodes is in a range from about 1 mm to about 5 mm, and a distance between the adjacent two driving sensing electrodes is in a range from about 1 mm to about 5 mm.

12. A driving method for driving a capacitive touch panel, comprising steps of:
providing a capacitive touch panel, the capacitive touch panel comprises a transparent conductive layer with anisotropic impedance located on the substrate, a lower impedance direction D and a higher impedance direction H are defined on the transparent conductive layer, the lower impedance direction D is perpendicular to the higher impedance direction H; a plurality of driving sensing electrodes located on the two opposite sides of the transparent conductive layer, the plurality of driving sensing electrodes is located along a direction perpendicular to the lower impedance direction D; at least one sensing unit connected to the plurality of driving sensing electrodes for scanning the plurality of driving sensing electrodes, and the at least one sensing unit comprises a read-out circuit; at least one voltage compensation unit is configured to provide an offset voltage and comprises a first end and a second end, the first end of at least one voltage compensation unit is connected to at least one of the plurality of driving sensing electrodes, the second end of at least one voltage compensation unit is connected to a grounding voltage;
sensing an input touch on the transparent conductive layer, and forming a touch capacitance;
sequentially scanning the plurality of driving sensing electrodes by the at least one sensing unit; in process of scanning each of the plurality of driving sensing electrodes, providing an offset voltage by the rest of the plurality of driving sensing electrodes thought the at least one voltage compensation unit; and
determining an input touch position by a charge parameter of the touch capacitance which is read out by the read-out circuit.

13. The driving method of claim 12, wherein the at least one sensing unit comprises a charge circuit, a storage circuit and the read-out circuit, the charge circuit and the storage circuit are connected in parallel, the read-out circuit is connected to the storage circuit.

14. The driving method of claim 13, wherein providing driving voltage by the charge circuit, the driving voltage is defined as Vᵢ, the offset voltage is defined as V_{Background}, and the V_{Background} is greater than 0 and less than 2Vᵢ.

15. The driving method of claim 12, wherein each of the plurality of driving sensing electrodes is simultaneously connected to one sensing unit and one voltage compensation unit, and the at least one sensing unit and the at least one voltage compensation unit are connected in parallel.

16. The driving method of claim 12, wherein one sensing unit is sequentially connected to each of the plurality of driving sensing electrodes; and when one of the plurality of driving sensing electrodes is connected to the at least one sensing unit, the rest of the plurality of driving sensing electrodes are connected to the at least one voltage compensation unit.

17. The driving method of claim 12, wherein the at least one voltage compensation unit is a power supply.

18. The driving method of claim 12, wherein when the plurality of driving sensing electrodes is scanned, the plurality of driving sensing electrodes is connected to the at least one sensing unit; and when the plurality of driving sensing electrodes is not scanned, the plurality of driving sensing electrodes is connected to the at least one voltage compensation unit.
